(19) United States
(12) Patent Application Publication
(10) Pub. No.: US 2009/0057039 A1
(43) Pub. Date: Mar. 5, 2009

(54) ELECTRONIC CIRCUIT

(76) Inventors: Tadahiro Kuroda, Yokohama-shi (JP); Daisuke Mizoguchi, Yokohama-shi (JP); Noriyuki Miura, Yokohama-shi (JP)

Correspondence Address: EDWARDS ANGELL PALMER & DODGE LLP, P.O. BOX 55874, BOSTON, MA, 02205, US

(21) Appl. No.: 11/659,111

(22) PCT Filed: Aug. 1, 2005
(86) PCT No.: PCT/JP2005/014063

§ 371 Date: Oct. 16, 2008

(30) Foreign Application Priority Data
Aug. 5, 2004 (JP) 2004-229941

(51) Int. Cl. H04B 5/00

(52) U.S. Cl. 178/43

(57) ABSTRACT

The invention provides an electronic circuit capable of simplifying a transmitter circuit and yet realizing low-voltage drive and low power consumption where communications between substrates are realized by inductive coupling. As the transmission data Txdata are turned from LOW to HIGH, the transistor T1 is turned from OFF to ON, and at the same time, the transistor T2 is turned from ON to OFF, wherein the current IT is caused to flow to the transmitter coil 14, and the capacitor 15 is charged. As the capacitor 15 is sufficiently charged, the current IT stops flowing. As a result, a pulse current of a triangular waveform is flown to the transmitter coil 14. Next, as the transmission data Txdata are turned from HIGH to LOW, the current IT is inversely flown to the transmitter coil 14, and the capacitor 15 is discharged, wherein a pulse current having a triangular waveform of reversed polarity is flown to the transmitter coil 14. Since discharge of the capacitor 15 is utilized to cause a pulse current of reversed polarity to flow, no power source current is used; subsequently, power can be saved.

### BACKGROUND OF THE INVENTION

1. Field of the Invention

The present invention relates to an electronic circuit that is capable of suitably carrying out communications between substrates such as IC (Integrated Circuit) bare chips, and PCBs (Printed Circuit Boards).

2. Description of the Related Arts

The present inventor et al. have proposed realizing a system in package (SiP) that is capable of sealing a plurality of bare chips in a package of LSI (Large Scale Integration) by utilizing a method for three-dimensionally mounting chips and electrically connecting between chips by means of inductive coupling (Patent Document 1).

FIG. 3 is a view depicting a configuration of an electronic circuit according to the invention of Japanese earlier application. The electronic circuit is composed of the first through the third LSI chips 31a, 31b and 31c, which is an example in which LSI chips are stacked up in three layers and a bus is formed so as to lie across three chips. That is, it composes a single communications channel capable of carrying out communications between the three (between three LSI chips). The first through the third LSI chips 31a, 31b and 31c are vertically stacked up, and the respective chips are fixed to each other with an adhesive agent. The first through the third transmitter coils 33a, 33b and 33c, which are respectively used for transmission, are formed by wiring on the first through the third LSI chips 31a, 31b and 31c, and also, the first through the third receiver coils 35a, 35b and 35c, which are respectively used for receiving, are formed by wiring thereon. These coils are disposed on the first through the third LSI chips 31a, 31b and 31c, so that the centers of the openings of the three pairs of transmitter and receiver coils 33 and 35 are made coincident with each other. Accordingly, the three pairs of transmitter and receiver coils 33 and 35 form inductive coupling, thereby enabling communications. The first through the third transmitter circuits 32a, 32b and 32c are connected to the first through the third transmitter coils 33a, 33b and 33c respectively, and the first through the third receiver circuits 34a, 34b and 34c are connected to the first through the third receiver coils 35a, 35b and 35c respectively. The transmitter and receiver coils 33 and 35 are three-dimensionally mounted as coils having one or more turns in an area permitted for communications, utilizing a multi-layered wiring of a process technology. A profile best suitable for communications exists in the transmitter and receiver coils 33 and 35, and it is necessary that they have an optimal number of times of winding, optimal opening, and optimal line width. Generally, the transmitter coils 33 are smaller than the receiver coils 35.

FIG. 4 is a view depicting a configurational example of a transmitter circuit used for an electronic circuit according to the invention of Japanese earlier application. The transmitter circuit is composed of a delay buffer 41, and transistors T7 through T10. The transistor T7 and transistor T8, and the transistor T9 and transistor 10 form an inverter having a CMOS (Complementary Metal Oxide Semiconductor) structure respectively, and function as a buffer, and drive the transmitter coil 42. As inputted transmission data Txdata are turned from LOW to HIGH, the data are inverted by the transistors T7 and T8 to cause a current IT to flow to the transmitter coil 42. Then, the data are delayed by the delay buffer 41, and are inverted by the transistors T9 and T10 to cause the current IT of the transmitter coil 42 to stop. Therefore, a pulse current of a triangular waveform is caused to flow to the transmitter coil 42. As the transmission data Txdata are turned from HIGH to LOW, a pulse current having a triangular waveform of reversed polarity is caused to flow to the transmitter coil 42.

[Patent Document 1] Japanese Patent Application No.

### DISCLOSURE OF THE INVENTION

### Problems to be Solved by the Invention

However, in the case of the above-described transmitter circuit, since a buffer is connected to every end of the transmitter coil 42, and the transmitter circuit is provided with a delay buffer 41 to cause the buffers to be actuated with a shift in terms of time, to cause a pulse current of a triangular waveform to flow to the transmitter coil 42, the circuit scale is large in size, which consequently makes power consumed in these circuits increased.

In addition, although it is preferable that the pulse current flown to the transmitter coil 42 is made linear in order to increase the electromotive force in the receiver coil, the flown pulse current tends to be smooth by a delay effect due to inductance of the transmitter coil 42, and resultantly a high-voltage power source is required in the transmitter circuit.

In view of the above-described situations, it is an object of the invention to provide an electronic circuit capable of simplifying the transmitter circuit and also capable of realizing low-voltage drive and low power consumption where communications between substrates are carried out by inductive coupling.

### Means for Solving the Problems

An electronic circuit according to the invention comprising: a first substrate including a selector circuit for outputting a first reference potential or a second reference potential in response to a transmission signal, a capacitor and a transmitter coil formed by wiring on the substrate, which are connected to each other in series, between output of said selector circuit and said first reference potential; and a second substrate including a receiver coil inductively coupled to said transmitter coil formed at a position corresponding to said transmitter coil by wiring on the substrate.

Further, since the selector circuit is composed of transistors having a CMOS structure, the circuit reduces power consumption and operates faster.

Also, since the selector circuit opens the transmitter coil while the coil does not transmit any signal, a closed transmitter coil could be prevented from interfering with changes in magnetic fluxes being received from other substrates.

### Effects of the Invention

According to the invention, where communications between substrates are carried out by inductive coupling, it is possible to simplify the transmitter circuit, and yet to realize low voltage drive and low consumption power.

The present specification includes the contents described in the specification and/or the drawings of Japanese Patent Application No. 2004-229941 which is the basis of priority of the present application.

### BRIEF DESCRIPTION OF THE DRAWINGS

FIG. 1 is a view depicting a configuration of a transmitter circuit in an electronic circuit according to an embodiment of the present invention;

FIG. 2A, FIG. 2B and FIG. 2C are views depicting voltage and current at respective parts;

FIG. 3 is a view depicting a configuration of an electronic circuit according to the invention of Japanese earlier application; and

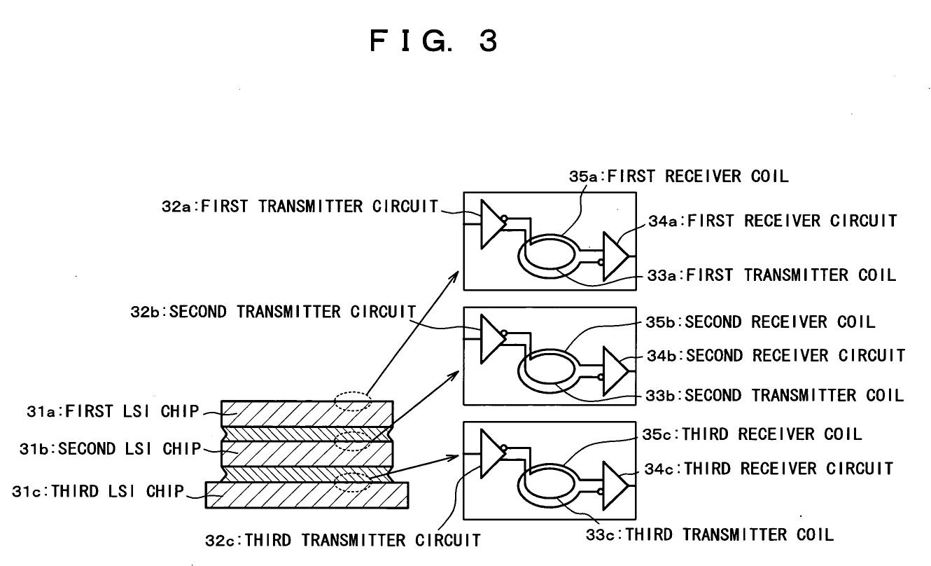

FIG. 4 is a view depicting a configurational example of a transmitter circuit used for an electronic circuit according to the invention of Japanese earlier application.

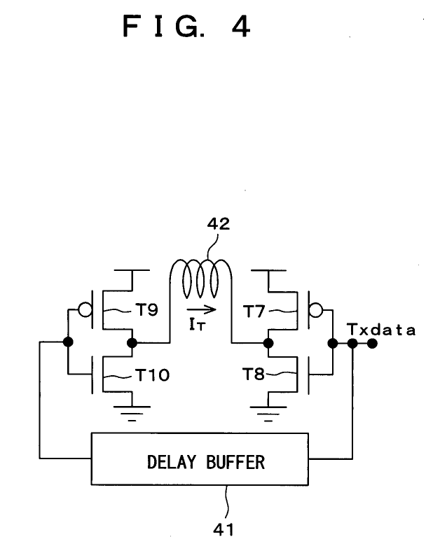

### DESCRIPTION OF REFERENCE SYMBOLS

11 NOT
12 NAND
13 NOR
14 Transmitter coil
Capacitor
Transmitter circuit
Transmitter coil
Receiver coil
Receiver circuit
Ammeter
LSI chip
Transmitter circuit
Transmitter coil
34 Receiver circuit
35 Receiver coil
41 Delay buffer
42 Transmitter coil
T1, T2, T7 through T10 Transistors
Txdata Transmission data

### BEST MODE FOR CARRYING OUT THE INVENTION

Hereinafter, a detailed description is given of a best mode by which the invention is embodied, with reference to the accompanying drawings.

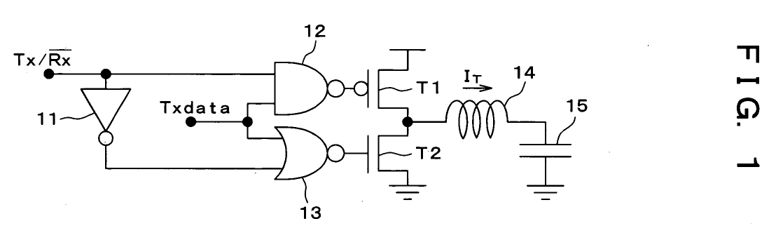

FIG. 1 is a view depicting a configuration of a transmitter circuit in an electronic circuit according to an embodiment of the present invention. The transmitter circuit is composed of NOT 11, NAND 12, NOR 13, transistors T1 and T2 and a capacitor 15 and drives a transmitter coil 14. The transistors T1 and T2 are identical to the transistors T7 and T8 that have been described as the related art, wherein a detailed description thereof is omitted. A signal Tx/bar(Rx) is a signal that is made HIGH while the chip is transmitting and is made LOW while receiving where it is assumed that, with respect to this communications channel, the chip receives data while the chip does not transmit data. Therefore, when the chip does not transmit (that is, in the embodiment, when the chip receives), since the signal Tx/bar(Rx) is LOW, output of the NOT 11 becomes HIGH, output of the NAND 12 becomes HIGH, and output of the NOR 13 becomes LOW, wherein the transistors T1 and T2 are turned off, and the transmitter coil 14 is opened. This prevents the closed transmitter coil 14 would interfere with changes in receiving magnetic fluxes. The capacitor 15 can be easily produced by using the capacitive of a MOS transistor. When transmitting, that is, when the Tx/bar (Rx) is HIGH, if inputted transmission data Txdata are turned from LOW to HIGH, the transistor T1 is turned from OFF to ON, and at the same time, the transistor T2 is turned from ON to OFF, wherein a current IT is caused to flow to the transmitter coil 14 to charge the capacitor 15. As the capacitor 15 is sufficiently charged, the current IT stops. As a result, a pulse current of a triangular waveform is caused to flow to the transmitter coil 14. Next, as the transmission data Txdata are turned from HIGH to LOW, the transistor T1 is turned from ON to OFF, and at the same time, the transistor T2 is turned from OFF to ON, wherein a current IT inversely flows to the transmitter coil 14 to discharge the capacitor 15. As the capacitor 15 is sufficiently discharged, the current IT stops, wherein a pulse current having a triangular waveform of reversed polarity is caused to the transmitter coil 14. In the case of this embodiment, discharge of the capacitor 15 is utilized to cause a pulse current of reversed polarity to flow, wherein no power source current is used, and power can be saved. In addition, since the delay buffer 41 can be omitted and two buffers (T7 through T10) for driving the transmitter coil 14 can be made into one (T1 and T2), power can be further saved. Further, since it is favorable that the charge/discharge current is linear where the capacitor is charged and discharged via a coil, it is possible to transmit a large signal from the transmitter coil 14 with small power; in this point, as well, the power can be saved, and low-voltage drive can be brought about.

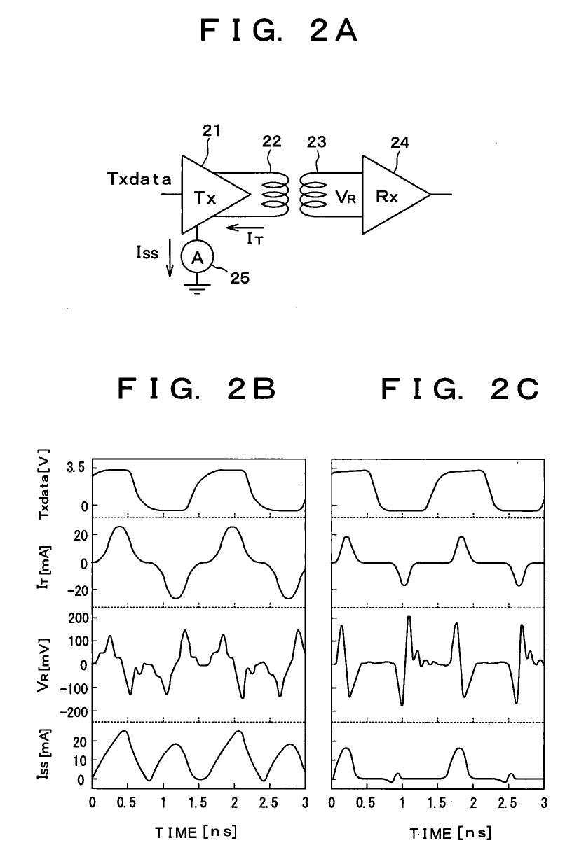

FIG. 2A, FIG. 2B and FIG. 2C are views depicting voltage and current at respective parts. In the transmitter circuit 21, transmitter coil 22, receiver coil 23, receiver circuit 24, and ammeter 25, FIG. 2B shows the transmission data Txdata, which are input of the transmitter circuit 21, current IT of the transmitter coil 22, voltage VR in the receiver coil 23, and power source current ISS flowing into the transmitter circuit 21 in the case of a transmitter circuit of the related art example, and FIG. 2C shows those in the case of the transmitter circuit according to the present embodiment. After the transmission data Txdata are turned from LOW to HIGH, the current IT slowly rises and slowly falls in FIG. 2B showing the related art example. However, the current IT straightly rises and straightly falls in FIG. 2C showing the present embodiment; therefore, it is sufficient that a small current IT is supplied. Even so, in FIG. 2C according to the present embodiment in comparison with FIG. 2B according to the related art example, it is understood that the peak value of the voltage VR in the receiver coil 23 is high, and a remarkably small amount of the power source current ISS of the transmitter circuit 21 is sufficient. Where the transmission data Txdata are turned from HIGH to LOW, it is understood that, in FIG. 2C according to the present embodiment in comparison with FIG. 2B according to the related art example, there is almost no power source current ISS in the transmitter circuit 21.

As described above, in the case of the present embodiment, (1) almost no power source current flows in the transmitter circuit 21 where the transmission data Txdata are turned from HIGH to LOW, (2) linearity of a current flowing in the transmitter coil 22 is satisfactory, and (3) small size in circuit configuration can further save power.

In addition, the present invention is not limited to the above-described embodiment.

The NOT 11, NAND 12 and NOR 13 prevent the closed transmitter coil 14 would interfere with changes in magnetic fluxes being received from other substrates. Therefore, if it does not cause a problem, these can be omitted.

The transistors T1 and T2 show a configurational example of a selector circuit for selectively connecting one end of the transmitter coil 14 to two potentials. Any other optional circuit having the functions of such a selector circuit may be employed.

If the transmitter coil 14 and the capacitor 15 are connected in series, there is no problem in switching around the two in terms of positions thereof.

All the publications, patents and patent applications cited in the present specification are taken in the present specification as references.

1: An electronic circuit comprising:
a first substrate including a selector circuit for outputting a first reference potential or a second reference potential in response to a transmission signal, a capacitor and a transmitter coil formed by wiring on the substrate, which are connected to each other in series, between output of said selector circuit and said first reference potential; and
a second substrate including a receiver coil inductively coupled to said transmitter coil formed at a position corresponding to said transmitter coil by wiring on the substrate.

2: The electronic circuit according to claim 1, wherein said selector circuit is composed of transistors having a CMOS structure.

3: The electronic circuit according to claim 1, wherein said selector circuit opens the transmitter coil while said transmitter coil does not transmit any signal.

4: The electronic circuit according to claim 2, wherein said selector circuit opens the transmitter coil while said transmitter coil does not transmit any signal.
